(19) United States
(12) Patent Application Publication
(10) Pub. No.: US 2026/0108834 A1
(43) Pub. Date: Apr. 23, 2026

(54) HVAC FILTER APPARATUS

(71) Applicant: RZ Industries LLC, Burnsville, MN (US)

(72) Inventor: Steve Gordon Torbenson, Burnsville, MN (US)

(21) Appl. No.: 19/114,296

(22) PCT Filed: Oct. 6, 2023
(86) PCT No.: PCT/US23/34687

§ 371 Date: Mar. 21, 2025

Related U.S. Application Data
(60) Provisional application No. 63/413,891, filed on Oct. 6, 2022.

(51) Int. Cl. B01D 46/00; B01D 46/10; F24F 8/108; F24F 13/28

(52) U.S. Cl. CPC B01D 46/0005; B01D 46/10; F24F 8/108; F24F 13/28; B01D 2265/024; B01D 2265/029; B01D 2265/04; B01D 2265/06; B01D 2271/02; B01D 2279/50

(57) ABSTRACT

Various environments exhibit undesirable air conditions, as may relate to particulates, odors, gas, vapors and/or airborne pathogens. For instance, public spaces such as hotel rooms, hospital rooms, apartments, assisted living homes and others may be subjected to such conditions. Existing air movement equipment, which may include heating, ventilating and air conditioning (HVAC) type equipment, may provide inadequate filtering capabilities. Certain applications involve filtering air provided by a room or area-specific heating, ventilating and/or air conditioning system. As a particular example, hotel and motel rooms are often heated, ventilated and cooled by a room-specific system. Such systems may utilize, for example, a ventilation mechanism that conveys air for heating or cooling the air in a fresh-air or recirculation mode, or simply for bringing fresh air in from outside the room. These room-specific systems often use filters in some manner. However, these filters are susceptible to damage and accumulation of dirt, bacteria and other undesirable contaminants. These and other matters have presented challenges to the use and implementation of filters for a variety of applications.

### BACKGROUND

Various environments exhibit undesirable air conditions, as may relate to particulates, odors, gas, vapors and/or airborne pathogens. For instance, public spaces such as hotel rooms, hospital rooms, apartments, assisted living homes and others may be subjected to such conditions. Existing air movement equipment, which may include heating, ventilating and air conditioning (HVAC) type equipment, may provide inadequate filtering capabilities.

Certain applications involve filtering air provided by a room or area-specific heating, ventilating and/or air conditioning system. As a particular example, hotel and motel rooms are often heated, ventilated and cooled by a room-specific system. Such systems may utilize, for example, a ventilation mechanism that conveys air for heating or cooling the air in a fresh-air or recirculation mode, or simply for bringing fresh air in from outside the room. These room-specific systems often use filters in some manner. However, these filters are susceptible to damage and accumulation of dirt, bacteria and other undesirable contaminants.

These and other matters have presented challenges to the use and implementation of filters for a variety of applications.

### SUMMARY

Aspects of the present disclosure are applicable to filter apparatuses and their implementation.

Accordingly, various example embodiments are directed to a filter apparatus and its use, which may address challenges such as those described in the Background section above. Aspects of the present disclosure are directed to filtering air passing into and/or out of an air movement component, such as a window air conditioning unit. Certain contexts involve an add-on type filter apparatus having an adjustable frame that can be coupled to such an air movement component. Specific embodiments are directed to a filter frame and related filter media configured to filter air exchanged via an HVAC unit. Certain such embodiments involve a filter frame that couples to wall or window-type HVAC equipment, for instance to seal to and filter air expelled from wall HVAC units utilized in hotel rooms, hotels, apartments or other environments. Other embodiments involve coupling to and/or around wall or ceiling vents.

A particular embodiment is directed to an apparatus including an adjustable frame and a filter. The adjustable frame includes first and second frame components, each frame component having opposing parallel sidewalls connected by an end sidewall. The opposing parallel sidewalls each have upper and lower channels extending along a length of the opposing parallel sidewalls. Each upper channel of the first frame component is slidably engaged with a corresponding upper channel of the second frame component, and each lower channel of the first frame component is slidably engaged with a corresponding lower channel of the second frame component. The frame components are thus together and form a rectangular area that is bound on two parallel sides by the opposing parallel sidewalls and bound on parallel ends respectively by the end sidewalls. The filter is coupled to the frame and configured to filter air flowing through the rectangular area.

A specific embodiment is directed to an apparatus including first and second filter frames that form a rectangular area, and a filter coupled to the frame to filter air flowing through the rectangular area. The first filter frame component has two opposing parallel sidewalls connected by an end sidewall, the opposing parallel sidewalls each having upper and lower channels extending along a length of the opposing parallel sidewalls. The second filter frame component also has two opposing parallel sidewalls connected by an end sidewall, the opposing parallel sidewalls each having upper and lower channels extending along a length of the opposing parallel sidewalls. The upper and lower channels of the first and second filter frame components being parallel to each other. Each upper channel of the second filter frame is configured to slidably engage with a corresponding upper channel of the first filter frame, therein locking the upper channels together. Each lower channel of the second filter frame is configured to slidably engage with a corresponding lower channel of the first filter frame, therein locking the lower channels together. The locked channels/filter frame components form the rectangular area that is bound on two sides by the opposing parallel sidewalls of both the first and second filter frame components, and bound on ends respectively by the end sidewalls of the first and second filter frame components, with the end sidewalls being parallel to one another.

Another embodiment is directed to a system including an air movement component having an air passageway through a surface and a filter apparatus sealed to the surface around the air passageway to filter air flowing through the air passageway. The filter apparatus includes first and second filter frame components, as well as a filter. The first filter frame component has two opposing parallel sidewalls connected by an end sidewall, the opposing parallel sidewalls each having upper and lower channels extending along a length of the opposing parallel sidewalls. The second filter frame component also has two opposing parallel sidewalls connected by an end sidewall, the opposing parallel sidewalls each having upper and lower channels extending along a length of the opposing parallel sidewalls. The upper and lower channels of the first and second filter frame components are parallel to each other. Each upper channel of the second filter frame is configured to slidably engage with a corresponding upper channel of the first filter frame, therein locking the upper channels together. Similarly, each lower channel of the second filter frame is configured to slidably engage with a corresponding lower channel of the first filter frame, therein locking the lower channels together. The locked filter frame components form a rectangular area that is: bound on two sides by the opposing parallel sidewalls of both the first and second filter frame components, and bound on ends respectively by the end sidewalls of the first and second filter frame components with the end sidewalls being parallel to one another. One or more fasteners are included to fasten the filter apparatus to the surface of the air movement component, and a filter is coupled to the frame to filter air flowing through the rectangular area and the air passageway.

The above overview is not intended to describe each embodiment or every implementation of the present disclosure. The figures and detailed description that follow also exemplify various embodiments.

### BRIEF DESCRIPTION OF FIGURES

Various example embodiments may be more completely understood in consideration of the following detailed description and in connection with the accompanying drawings, in which:

FIGS. 1A-1C depict a filter apparatus, in accordance with one or more embodiments, in which:

FIG. 1A depicts the filter apparatus in an expanded state,

FIG. 1B depicts the filter apparatus in a collapsed state, and

FIG. 1C depicts an end view of the filter apparatus;

FIGS. 2A and 2B depict filter frame components of an assembly of the filter apparatus shown in FIG. 1;

FIG. 3 depicts a filter apparatus with overlapping gaskets, as may be implemented with the apparatus shown in FIG. 1;

FIGS. 4A and 4B depict an isometric view of a filter apparatus, as may be implemented with the apparatus shown in FIG. 1, in which

FIG. 4A depicts the apparatus in a locked state; and

FIG. 4B depicts the apparatus shown in FIG. 4A with a filter coupled thereto; and

FIG. 5 depicts a fastener that may be utilized in connection with the apparatus shown in FIG. 1.

While various embodiments discussed herein are amenable to modifications and alternative forms, aspects thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the disclosure including aspects defined in the claims. In addition, the term “example” as may be used throughout this application is by way of illustration, and not limitation.

### DETAILED DESCRIPTION

Aspects of the present disclosure are believed to be applicable to a variety of different types of articles of manufacture, apparatuses, systems and methods involving filter apparatuses. In certain implementations, aspects of the present disclosure have been shown to be beneficial when used in the context of a filter apparatus for coupling to existing air movement equipment for adding filtration capabilities. Particular embodiments are directed to a filter apparatus having a frame and related componentry that may be coupled to an in-wall or in-window HVAC unit (as may for example be a window air conditioner), with filter material held by the frame and operable to filter air provided from and/or to the HVAC unit. Certain embodiments involve coupling the filter apparatus to an HVAC unit (e.g., over airflow openings therein), and other embodiments may involve coupling the filter apparatus around such a unit. Yet other embodiments may involve coupling the apparatus to and/or around a vent in a wall, ceiling, vehicle or otherwise. While not necessarily so limited, various aspects may be appreciated through a discussion of examples using such exemplary contexts.

According to various example embodiments, an apparatus includes a filter frame configured to hold a filter relative to an HVAC unit. The frame has two or more components that may slidably engage. These components may be engaged to different extents to provide filter frames of varying sizes. The frame is configured and arranged to form an air flow channel sealed around an inlet and/or outlet of the HVAC unit, and to filter air flowing through the air flow channel, therein filtering air moving into our out of the air movement component.

Various embodiments are directed to implementation with aspects of the disclosure in the underlying U.S. Provisional Patent Application having Ser. No. 63413891 and filed on Oct. 6, 2022, which depicts filter apparatuses and which is fully incorporated herein by reference.

A specific embodiment is directed to an apparatus including first and second filter frames that form a rectangular area having sidewalls and end walls enclosing a volume, and a filter coupled to the frame to filter air flowing through the rectangular area. The first filter frame component has two opposing parallel sidewalls connected by an end sidewall, in which the opposing parallel sidewalls each have upper and lower channels extending along a length thereof. The second filter frame component also has two opposing parallel sidewalls connected by an end sidewall, the opposing parallel sidewalls each having upper and lower channels extending along a length of the opposing parallel sidewalls.

The upper and lower channels of the first and second filter frame components are parallel to each other (i.e., all channels of the apparatus run in parallel). Each upper channel of the second filter frame slidably engages with a corresponding upper channel of the first filter frame, therein locking the upper channels together. For instance, each filter frame may include one male and one female channel to respectively engage with a female and male channel of the other filter frame. Similarly, each lower channel of the second filter frame slidably engages with a corresponding lower channel of the first filter frame, therein locking the lower channels together. The locked channels/filter frame components form the rectangular area defining a volume that is bound on two sides by the opposing parallel sidewalls and on ends by the end sidewalls, with openings defined by perimeters of the upper channels and lower channels, respectively. A perimeter of the filter may be sealed to a perimeter of the rectangular area. One or both of the first and second filter frames may include fasteners adjacent the lower channels to seal a perimeter of the apparatus to a surface around an air passageway of an air movement component.

The channels may lock together in a variety of manners, with certain examples shown in the figures. For instance, one or both of the upper channels of the first filter frame component may have a locking mechanism configured to engage with one of the upper channels of the second filter frame component, and therein lock the engaged upper channels together. Similarly, one or both of the lower channels of the first filter frame component may have a locking mechanism configured to engage with one of the lower channels of the second filter frame component and therein lock the engaged lower channels together. Either of the frame components may have such locking mechanisms, such that each pair of channels that engage with one another includes one channel with a locking mechanism and the other channel engaged therewith.

In a particular instance, one of each of the upper and lower channels of the first filter frame component has a locking mechanism to respectively engage with one of the corresponding upper and lower channels of the second filter frame component and therein lock the engaged upper channels together. The engaged channels may include a U-shaped (e.g., female) channel and a J-shaped (e.g., male) channel locked to slide within the U-shaped channel. For instance, outer surfaces of the J-shaped channel may slidably interface with inner surfaces of the U-shaped channel, providing rigidity to the formed filter frame. In some implementations, one of the upper channels of the first filter frame component has a U shape and a series of tabs within the U shape that form a gap between the tabs and an upper surface of the U shape, and one of the upper channels of the second filter frame component that is configured to slidably engage with the one of the upper channels of the first filter frame component has a J shape sized in width and thickness to slide within the gap and therein lock the respective upper channels in sliding engagement with one another.

In certain instances, for respective pairs of upper channels of the first and second filter frame that are slidably engaged with one another, one of the upper channels has a U-shape and the other of the upper channels has a J-shape sized to fit within an interior region of the U-shape and having outer surface areas in contact with inner surface areas of the U-shape, therein locking the respective pairs of upper channels to one another.

The filter frame components may be sealed around an opening in a variety of manners. For instance, each of the first and second filter frame components may include a seal extending longitudinally along each of the lower channels thereof. The respective seals of each of the first and second filter frame components are aligned in parallel to one another and overlap laterally with the upper and lower channels locked together. A seal may be integrated into a lower edge of the end wall portions such that a seal may be provided around a perimeter of an airflow opening in an HVAC unit.

Another embodiment is directed to a system including an air movement component having an air passageway through a surface and a filter apparatus sealed to the surface around the air passageway to filter air flowing through the air passageway. The air movement component may include some or all of an HVAC type component. For example, the air movement component may be a shell that covers operational equipment that provides heated and/or cooled airflow through the air passageway. The component may include an entire window or wall air conditioning apparatus as may for example include a compressor, fan, control circuitry and other parts that provide an operational air conditioner.

The filter apparatus includes first and second filter frame components, as well as a filter. The first and second filter frame components each have two opposing parallel sidewalls connected by an end sidewall, the opposing parallel sidewalls each having upper and lower channels extending along a length of the opposing parallel sidewalls. The upper and lower channels of the first and second filter frame components are parallel to each other. Each upper channel of the second filter frame is configured to slidably engage with a corresponding upper channel of the first filter frame, therein locking the upper channels together. Similarly, each lower channel of the second filter frame is configured to slidably engage with a corresponding lower channel of the first filter frame, therein locking the lower channels together. The locked filter frame components form a rectangular area that is bound on two sides by the opposing parallel sidewalls of both the first and second filter frame components and on ends by the end sidewalls.

One or more fasteners are included to fasten the filter apparatus to the surface of the air movement component, and a filter is coupled to the frame to filter air flowing through the rectangular area and the air passageway. Such a fastener may include an adhesive component to adhere to the surface of the air movement component, and a threaded bolt shaft to secure the first and second filter frames to the fastener and, via the adhesive component, to the surface of the air movement component.

The upper and lower channels of the system may be implemented in a variety of manners. For instance, the upper and lower channels of the first filter frame component has a locking mechanism configured to engage with one of the channels of the second filter frame component and therein lock the engaged channels together. The respective channels that lock together may include a U-shaped (e.g., female) channel and a J-shaped (e.g., male) channel configured to slide within the U-shaped channel, or a U-shaped channel and a lip locked to slide within the U-shaped channel. In a specific embodiment, an upper channel each of the first and second filter frame components has a U shape and a series of tabs within the U shape that form a gap between the tabs and an upper surface of the U shape, and the other upper channel of each frame component has a J shape sized in width and thickness to slide within the gap and therein lock the respective upper channels in sliding engagement with one another.4

Various embodiments are directed to such apparatuses having various lengths, widths and heights, for example to cover different sized openings. Where larger openings are covered, the apparatus may be formed with additional structural support such as with relatively thicker or stronger material, or mechanical features that enhance stiffness.

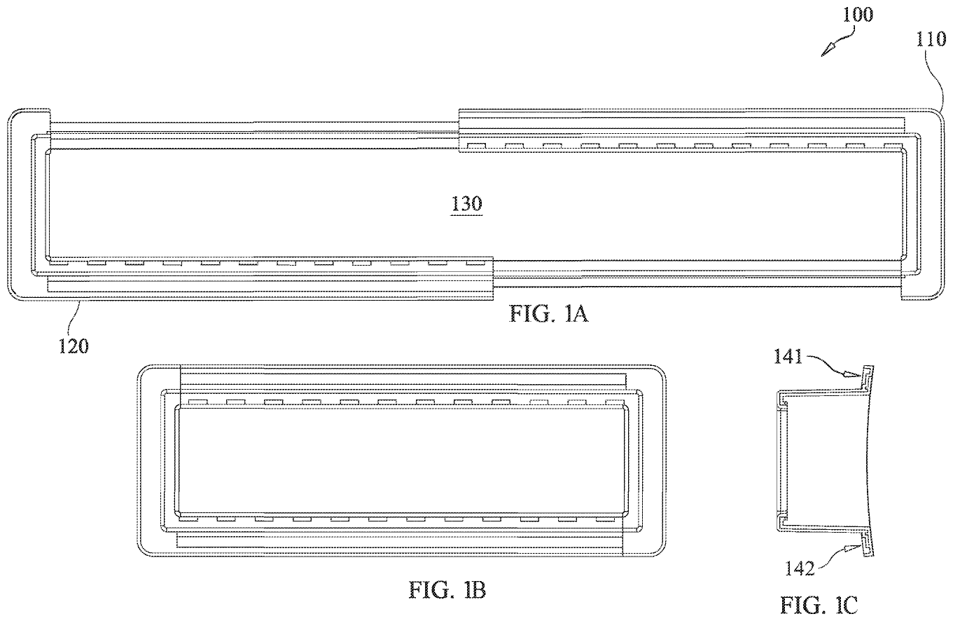

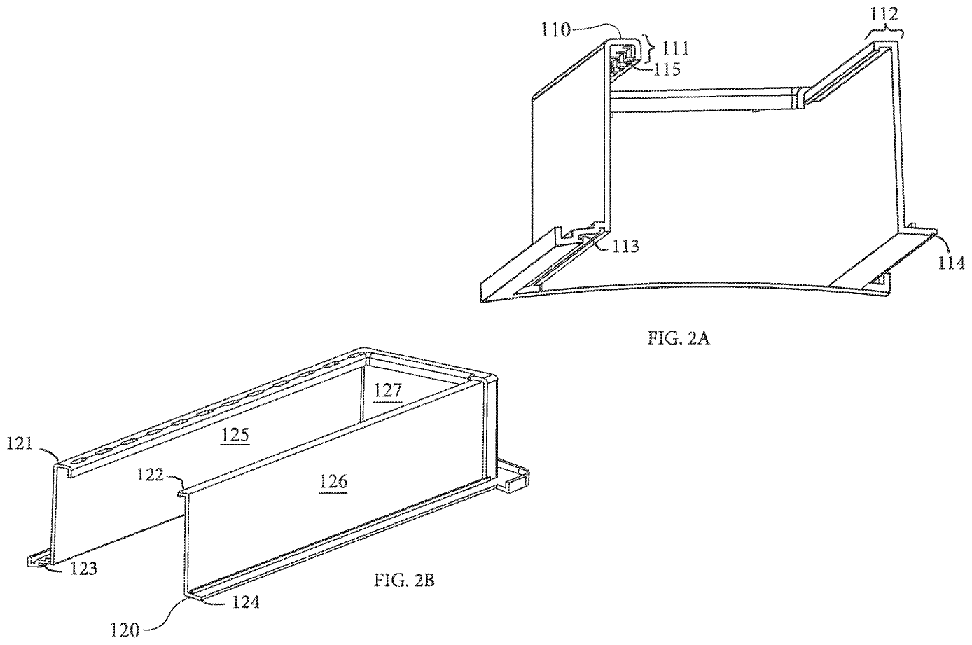

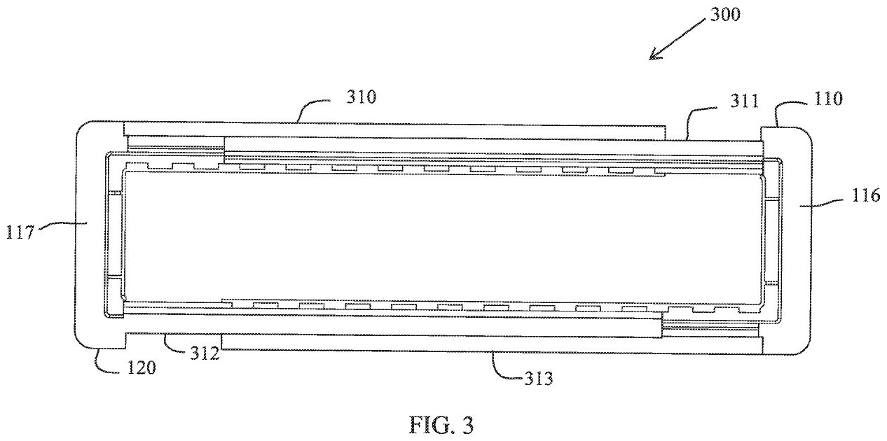

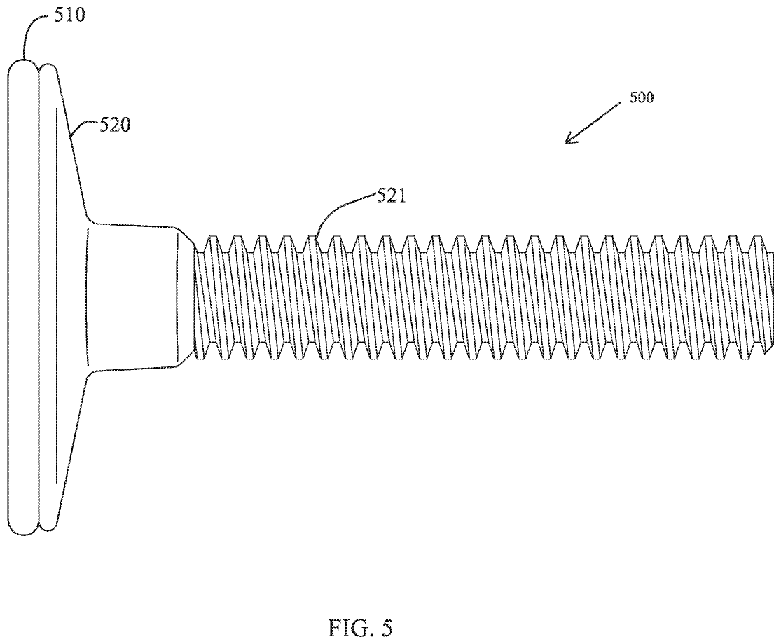

As utilized herein, a “U” shape involves a structure having two opposing sidewalls in parallel and facing one another, with a connecting end sidewall that connects the two opposing sidewalls in a generally perpendicular direction relative to the opposing sidewalls. Different widths between the opposing sidewalls may be provided to suit particular applications, for instance to form a rectangular opening having pronounced spacing between the opposing sidewalls, or a small slot in which spacing between sidewalls may be sized to accept a flat piece. A “J” shape involves a structure having a sidewall and an end wall connected to the sidewall in a generally perpendicular direction relative to a surface of the sidewall. Referring to the figures, such “U” shapes may be implemented as shown in FIG. 2 and described in connection with U-shaped portions 111 and 121, or with U-shaped slots 113 and 123 as may respectively interface/lock with portions 124 and 114. Such “J” shapes may be implemented as shown in FIG. 2 and described in connection with J-shaped portions 112 and 122. Turning now to the figures, FIGS. 1A-1C show an apparatus 100 configured to couple to filter air passing to/from an HVAC unit and/or vent type opening. The apparatus has right and left filter frame portions 110 and 120 that slidably engage with one another, each having opposing parallel sidewalls connected by an end sidewall, with opposing parallel sidewalls 125/126 and end sidewall 127 labeled in frame portion 120 by way of example. The end portions may be adjusted to provide varying widths, for instance in an extended/wider configuration as shown in FIG. 1A, and in a collapsed/narrow configuration as shown in FIG. 1B. The depth of the apparatus may vary, for example as 2.3″ by way of example. A filter material may be contained within the structure at 130 (e.g., a 2″ thick filter with an apparatus width of 2.3″). Alternately or in addition, the filter material may be coupled to a top outer surface of the apparatus, for instance above channels in which respective components slide. A sealing material such as foam or rubber may be utilized around a perimeter of the apparatus, such as depicted in FIG. 3. Further, fasteners may be implemented at regions 141 and 142, for example as depicted in FIG. 5 and described below.

FIGS. 2A and 2B depict respective filter frame components 110 and 120 of an assembly of the filter apparatus shown in FIG. 1, as may be implemented in accordance with one or more embodiments. Referring to FIG. 2A, a U-shaped channel 111 of filter frame component 110 is depicted with tabs 115 that facilitate sliding insertion of a J-shaped channel 122 of filter frame component 120 into the channel 111. Similarly, U-shaped channel 121 of filter frame component 120 facilitates sliding insertion of J-shaped channel 112. A lower channel 113 (slot-shaped) of the filter frame component 110 facilitates insertion of a lip 124 of filter frame component 120. Similarly, lower channel/slot 123 of filter frame component 120 facilitates insertion of a lip 114 of filter frame component 110. In this regard, when slidably engaged the respective filter frame components 110 and 120 may be utilized to provide a filter apparatus of selectable width.

FIG. 3 depicts a filter apparatus 300 with overlapping gaskets, as may be implemented with the apparatus shown in FIG. 1 such that filter frame components 110 and 120 are labeled similarly. Gaskets 311 and 313 are coupled to filter frame component 110, and gaskets 310 and 312 are coupled to filter frame component 120. Accordingly, gaskets 310 and 311 overlap laterally and operate to seal the upper side of the apparatus 300. End gaskets 116 and 117 may be provided on an underside of end sidewalls of the respective filter frame components 110 and 120 as shown. As such, gaskets may be provided around a perimeter of the apparatus 300 along lower channels thereof, as well as a lower portion of the end sidewalls.

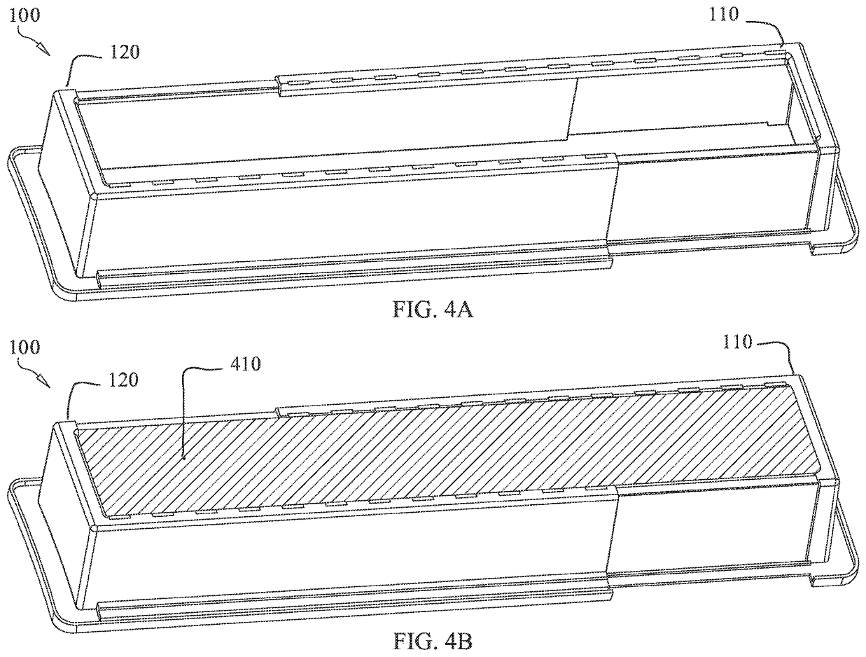

FIGS. 4A and 4B depict an isometric view of a filter apparatus, as may be implemented with the apparatus shown in FIG. 1, each having respective filter frame components 110 and 120 labeled as such. The filter apparatuses shown have respective parallel opposing sidewalls and parallel end walls formed by the filter frame components slidably locked together and defining a rectangular area that is bound on two sides by the opposing parallel sidewalls of both the first and second filter frame components, and bound on ends respectively by the end sidewalls of the first and second filter frame components which are parallel to one another. FIG. 4B shows a filter 410 located within the rectangular area and operable to filter air flowing through openings in a surface to which the apparatus may be coupled. Alternately, filter 410 may be coupled to an upper surface of the apparatus, for instance around a perimeter of the slidably locked upper channels.

Various types of filter material may be used for the filter 410 and/or as otherwise used in connection with one or more embodiments noted herein. For instance, active carbon panels may be utilized to facilitate the reduction of odors and fumes. Other filter media may be used to provide enhanced particular filtering. A combination of filter types may be used, for instance to filter particles and reduce odors/fumes. In still other embodiments, filters having multiple types of filtration material is used (e.g., both active carbon and microfiber, or a filter material exhibiting both active carbon and microfiber). In still other embodiments, different types of filters are used for intake and exhaust vents, for instance by coupling the claimed apparatus to HVAC equipment such that a fiber-based particulate filter is aligned to one of intake and exhaust vents, and an active carbon filter is aligned to the other one of the intake and exhaust vents.

As described herein, a variety of fasteners can be used to couple the filter apparatuses described, for instance by coupling a perimeter around the lower channels of slidably engaged frame components to a surface of a window air conditioning unit. Adhesive, hook-and-loop fasteners, snaps or other fasteners may be used in this regard.

FIG. 5 depicts a fastener 500 used in connection with a particular embodiment. The fastener 500 includes a head 520 coupled to a threaded section 521, and an adhesive 510 to couple the head to a surface of HVAC equipment. Several of such fasteners may be utilized, for example, with the adhesive coupled to a surface of HVAC equipment and the threaded section protruding through a flange/lower channel of a filter apparatus as depicted herein. For instance, such fasteners may be used at regions 141 and 142 depicted in FIG. 1C.

In some implementations, an elastic type material may be used to enhance sealing of the filter apparatus to HVAC equipment. For instance, memory foam may be utilized along the edges of the apparatus on the backside such as shown in FIG. 3, as may be integrated with or coupled to a frame, for engaging with HVAC equipment.

In addition to the embodiments shown in the figures, various other shapes, sizes and arrangements may be utilized in the context of the present disclosure. For instance, square vents, rectangular vents, round vents, oval vents, or vents of various shapes may be implemented using a similar attachment system and or panel replacement system for customizing filtering.

In addition to the above, various embodiments may be implemented in connection with one or more aspects disclosed in PCT Patent Application No. PCT/US22/45920 entitled “Filter Apparatus” and filed on Oct. 6, 2022, which is fully incorporated herein by reference. For instance, one or more fasteners may be utilized in a similar manner to couple the apparatuses described herein to an opening in an air flow path, such as by coupling to louvers and/or around such an opening.

Based upon the above discussion and illustrations, those skilled in the art will readily recognize that various modifications and changes may be made to the various embodiments without strictly following the exemplary embodiments and applications illustrated and described herein. For example, different shapes and sizes of filter frames and filters may be utilized. Such modifications do not depart from the true spirit and scope of various aspects of the invention, including aspects set forth in the claims.

What is claimed is:

1. An apparatus comprising:
a first filter frame component having two opposing parallel sidewalls connected by an end sidewall, the opposing parallel sidewalls each having upper and lower channels extending along a length of the opposing parallel sidewalls;
a second filter frame component having two opposing parallel sidewalls connected by an end sidewall, the opposing parallel sidewalls each having upper and lower channels extending along a length of the opposing parallel sidewalls, the upper and lower channels of the first and second filter frame components being parallel to each other, wherein:
each upper channel of the second filter frame is configured to slidably engage with a corresponding upper channel of the first filter frame, therein locking the upper channels together, and
each lower channel of the second filter frame is configured to slidably engage with a corresponding lower channel of the first filter frame, therein locking the lower channels together and forming a rectangular area that is: bound on two sides by the opposing parallel sidewalls of both the first and second filter frame components, and bound on ends respectively by the end sidewalls of the first and second filter frame components with the end sidewalls being parallel to one another; and
a filter coupled to the frame and configured to filter air flowing through the rectangular area.

2. The apparatus of claim 1, wherein one of the upper channels of the first filter frame component has a locking mechanism configured to engage with one of the upper channels of the second filter frame component and therein lock the engaged upper channels together.

3. The apparatus of claim 1, wherein one of the lower channels of the first filter frame component has a locking mechanism configured to engage with one of the lower channels of the second filter frame component and therein lock the engaged lower channels together.

4. The apparatus of claim 1, wherein:
one of the upper channels of the first filter frame component has a locking mechanism configured to engage with one of the upper channels of the second filter frame component and therein lock the engaged upper channels together; and
one of the lower channels of the first filter frame component has a locking mechanism configured to engage with one of the lower channels of the second filter frame component and therein lock the engaged lower channels together.

5. The apparatus of claim 4, wherein one of the engaged upper channels includes a U-shaped channel and the other one of the engaged upper channels includes a J-shaped channel locked to slide within the U-shaped channel.

6. The apparatus of claim 4, wherein one of the engaged lower channels includes a U-shaped channel and the other one of the engaged lower channels includes a lip locked to slide within the U-shaped channel.

7. The apparatus of claim 1, wherein:
one of the upper channels of the first filter frame component has a U shape and a series of tabs within the U shape that form a gap between the tabs and an upper surface of the U shape; and
one of the upper channels of the second filter frame component that is configured to slidably engage with the one of the upper channels of the first filter frame component has a J shape sized in width and thickness to slide within the gap and therein lock the respective upper channels in sliding engagement with one another.

8. The apparatus of claim 1, wherein, for respective pairs of upper channels of the first and second filter frame that are slidably engaged with one another, one of the upper channels has a U-shape and the other of the upper channels has a J-shape sized to fit within an interior region of the U-shape and having outer surface areas in contact with inner surface areas of the U-shape, therein locking the respective pairs of upper channels to one another.

9. The apparatus of claim 1, wherein the first and second filter frames include fasteners adjacent the lower channels, the fasteners being configured to seal a perimeter of the apparatus to a surface around an air passageway of an air movement component.

10. The apparatus of claim 1, wherein the filter has a perimeter sealed to a perimeter of the rectangular area.

11. The apparatus of claim 1, wherein each of the first and second filter frame components includes a seal extending longitudinally along each of the lower channels thereof, and wherein the respective seals of each of the first and second filter frame components are aligned in parallel to one another and overlap laterally with the upper and lower channels locked together.

12. A system comprising:
an air movement component having an air passageway through a surface; and
a filter apparatus sealed to the surface around the air passageway to filter air flowing through the air passageway, the filter apparatus including:
a first filter frame component having two opposing parallel sidewalls connected by an end sidewall, the opposing parallel sidewalls each having upper and lower channels extending along a length of the opposing parallel sidewalls;
a second filter frame component having two opposing parallel sidewalls connected by an end sidewall, the opposing parallel sidewalls each having upper and lower channels extending along a length of the opposing parallel sidewalls, the upper and lower channels of the first and second filter frame components being parallel to each other, wherein:
each upper channel of the second filter frame is configured to slidably engage with a corresponding upper channel of the first filter frame, therein locking the upper channels together, and
each lower channel of the second filter frame is configured to slidably engage with a corresponding lower channel of the first filter frame, therein locking the lower channels together and forming a rectangular area that is: bound on two sides by the opposing parallel sidewalls of both the first and second filter frame components, and bound on ends respectively by the end sidewalls of the first and second filter frame components with the end sidewalls being parallel to one another;
at least one fastener to fasten the filter apparatus to the surface of the air movement component; and
a filter coupled to the frame and configured to filter air flowing through the rectangular area and the air passageway.

13. The system of claim 12, wherein the at least one fastener includes an adhesive component to adhere to the surface of the air movement component, and a threaded bolt shaft to secure the first and second filter frames to the fastener and, via the adhesive component, to the surface of the air movement component.

14. The system of claim 12, wherein at least one of the upper channels and the lower channels of the first filter frame component has a locking mechanism configured to engage with one of the channels of the second filter frame component and therein lock the engaged channels together.

15. The system of claim 12, wherein, for each filter frame component,
one of the upper channels includes a U-shaped channel and the other one of the upper channels includes a J-shaped channel configured to slide within the U-shaped channel; and
one of the lower channels includes a U-shaped channel and the other one of the engaged lower channels includes a lip locked to slide within the U-shaped channel.

16. The system of claim 12, wherein:
one of the upper channels of the first filter frame component has a U shape and a series of tabs within the U shape that form a gap between the tabs and an upper surface of the U shape; and
one of the upper channels of the second filter frame component that is configured to slidably engage with the one of the upper channels of the first filter frame component has a J shape sized in width and thickness to slide within the gap and therein lock the respective upper channels in sliding engagement with one another.

17. An apparatus comprising:
an adjustable frame including:
first and second frame components, each frame component having opposing parallel sidewalls connected by an end sidewall, the opposing parallel sidewalls each having upper and lower channels extending along a length of the opposing parallel sidewalls, each upper channel of the first frame component being slidably engaged with a corresponding upper channel of the second frame component and each lower channel of the first frame component being slidably engaged with a corresponding lower channel of the second frame component, therein locking the frame components together and forming a rectangular area that is bound on two parallel sides by the opposing parallel sidewalls and bound on parallel ends respectively by the end sidewalls; and
a filter coupled to the frame and configured to filter air flowing through the rectangular area.
